(19) United States
(12) Patent Application Publication
(10) Pub. No.: US 2026/0288452 A1
(43) Pub. Date: Sep. 24, 2026

(54) ENHANCED OVER-THE-AIR PROGRAMMING OF POWER MANAGEMENT INTEGRATED CIRCUITS

(71) Applicant: Rivian IP Holdings, LLC, Irvine, CA (US)

(72) Inventors: Srinivasa Sastry GUNTUR, Charlotte, NC (US); Vasant Kumar EASWARAN, Frisco, TX (US); Tyler PRICE, Mountain View, CA (US); Marc HAEBERLIN, Palo Alto, CA (US); Loc T. LE, San Jose, CA (US)

(21) Appl. No.: 19/088,788

(22) Filed: Mar. 24, 2025

(51) Int. Cl. G06F 8/658

(52) U.S. Cl. CPC G06F 8/658

(57) ABSTRACT

The subject technology provides for upgrading firmware in power management integrated circuits (PMICs) of an automotive system using over-the-air (OTA) updates, which is challenging due to limited storage in PMICs. The automotive system includes a first ECU that includes a first PMIC and a first processor, and a second ECU that includes a second PMIC and a second processor. The first processor may serve as a master and the second PMIC may serve as a slave during an OTA update of the second PMIC. The first processor can initiate the OTA update of the second PMIC and determine that the OTA update completed successfully. Based on the successful completion of the OTA update, the first processor causes the second processor to power on and disable a connection between the first processor and the second PMIC to allow an OTA update between the second processor and the first PMIC.

### INTRODUCTION

This application is directed to power management systems for electric vehicles, such as enhanced over-the-air programming of power management integrated circuits.

### SUMMARY

The subject technology provides for upgrading firmware in power management integrated circuits (PMICs) of an automotive system using over-the-air (OTA) updates, which is challenging due to limited storage in PMICs. The subject technology leverages multiple electronic control units (ECUs) connected via a shared communication bus to orchestrate OTA updates, facilitating reliability through integrity checks and retries. The OTA process involves programming PMICs sequentially and managing power states to avoid system failures.

### BRIEF DESCRIPTION OF THE DRAWINGS

Certain features of the subject technology are set forth in the appended claims. However, for purpose of explanation, several embodiments of the subject technology are set forth in the following figures.

FIG. 1A illustrates a schematic overhead view of example implementations of a vehicle in accordance with one or more implementations.

FIG. 1B illustrates a schematic side view of example implementations of a vehicle in accordance with one or more implementations.

FIG. 2 illustrates an exemplary block diagram of a power management system that includes a power management integrated circuit and a peripheral processor in accordance with one or more implementations.

FIG. 3 illustrates an exemplary block diagram of enhanced over-the-air programming of power management integrated circuits between interconnected in-vehicle electronic control units in accordance with one or more implementations.

FIG. 4 is a flow chart of illustrative operations that may be performed for enhanced over-the-air programming of power management integrated circuits in accordance with one or more implementations.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In the automotive sector, over-the-air (OTA) software updates are increasingly adopted to upgrade vehicle features over their operational lifetime, facilitating the development of software-defined vehicles. These software updates are typically implemented on most processors integrated into various in-vehicle electronic control units (ECUs), which have the capability to reprogram the non-volatile storage medium that retains their executable images. This enables vehicles to incorporate new features and resolve software-related issues without requiring physical service center visits or frequent hardware upgrades.

The power supplies supporting ECU components have become increasingly complex, integrating additional functionality related to safety, housekeeping, vehicle power modes, and wake-up requirements to improve efficiency and range. These power supply updates are beneficial for maintaining vehicle performance and functionality. As power management integrated circuits (PMICs) feature relatively small non-volatile storage capacity, traditional OTA update approaches cannot be directly applied.

In one or more implementations, PMICs perform multiple functions in addition to supplying power to ECU components. These functions include voltage monitoring of both internal and external rails, temperature monitoring of critical hotspots on the board, processor monitoring through watchdog timers, safe communication with processors utilizing cyclic redundancy checks, and controlled state transitions in response to processor or PMIC failures by shutting down power supplies.

These functionalities may require complex firmware logic implemented within PMICs, stored in non-volatile memory to allow retrieval during operation. The non-volatile storage available in PMICs is significantly smaller, measured in kilobytes (KB), compared to the megabyte (MB)-scale storage used in processors. Due to this limited storage capacity, traditional OTA programming approaches cannot rely on redundant memory to mitigate corruption risks during firmware updates.

The subject technology provides for a master processor to monitor PMIC error responses and initiate retries of the OTA update process until successful completion. As PMICs integrate more features, the need for dedicated housekeeping MCUs within the system has been largely reduced, preventing the master processor role from being executed within a local ECU. Since a vehicle contains multiple ECUs interconnected through communication buses, utilizing processors from peripheral processor 220s as master processors for managing OTA programming presents an efficient approach.

The subject technology can reduce reliance on additional MCUs, optimize resource utilization within the vehicle, and ensure PMIC firmware remains updated in accordance with evolving vehicle features. OTA updates may include support for new vehicle power modes, wake-up requirements for efficiency and range improvements, additional monitoring capabilities, and software modifications to address issues identified during field operation.

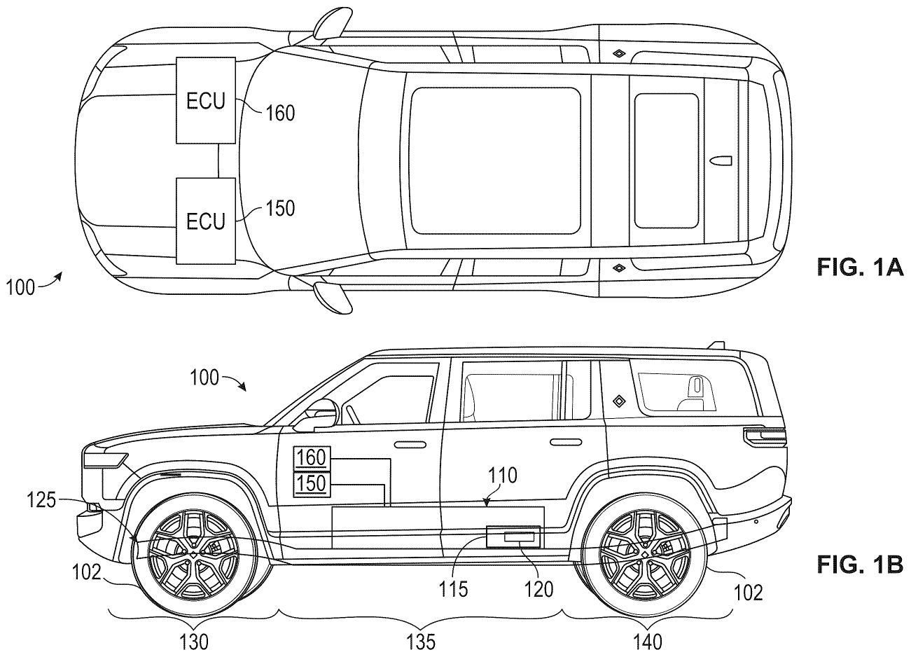

FIG. 1A illustrates an example overhead view of vehicle 100. As further described herein, vehicle 100 may include ECUs in front portion 130 of vehicle 100 (e.g., ECU 160 and ECU 170), among other things. In one or more implementations, ECU 150 may operate components on a first side of a longitudinal axis of vehicle 100, while the ECU 160 may operate components on a second side of the longitudinal axis. The longitudinal axis may be defined as a virtual line running from the front of vehicle 100 to the rear along its center, dividing vehicle 100 into the first (e.g., left) and second (e.g., right) sides. An ECU (e.g., ECU 150, ECU 160) is an embedded system that may control one or more of the electrical systems or subsystems in the vehicle 100.

FIG. 1B illustrates an example side view of vehicle 100. As shown, the vehicle 100 may include one or more battery packs, such as high voltage (HV) battery pack 110 (e.g., 450V), which may be located near the center body portion 135 of vehicle 100. HV battery pack 110 may be coupled with one or more electrical systems of the vehicle 100 to provide power to the electrical systems. In one or more implementations, ECU 150 or ECU 160 may be communicatively connected with or have power distributed with each other and may be functionally redundant for power or other operations of electronic components of vehicle 100.

In one or more implementations, the vehicle 100 may be an electric vehicle having one or more electric motors that drive wheels 102 of the vehicle 100 using electric power from HV battery pack 110. In one or more implementations, vehicle 100 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 100 may be implemented as a truck (e.g., a pickup truck) having a battery pack 110. As shown, HV battery pack 110 may include one or more battery modules 115, which may include one or more battery cells 120. However, this is merely illustrative and, in other implementations, HV battery pack 110 may be provided without any battery modules 115 (e.g., in a cell-to-pack configuration).

As shown in FIG. 1B, vehicle 100 may include a support structure such as a chassis 125 (e.g., a frame, internal frame, or other support structure). The chassis 125 may support various components of the vehicle 100. As shown, the chassis 125 may span a front portion 130 (e.g., a hood or bonnet portion), center body portion 135, and a rear portion 140 (e.g., a trunk, payload, or boot portion) of the vehicle 100 in some implementations. In one or more implementations, HV battery pack 110 may be installed on the chassis 125 (e.g., within one or more of the front portions 130, center body portion 135, or the rear portion 140). In one or more other implementations, HV battery pack 110 may include or be electrically coupled with one or more one busbars (e.g., one or more current collector elements), of which may include electrically conductive material to connect or otherwise electrically couple battery module(s) 115 or the battery cell(s) 120 with other electrical components of vehicle 100 to provide electrical power to various systems or components of vehicle 100.

In one or more other implementations, the vehicle 100 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having a battery pack 110 (e.g., that powers the propulsion or drive components of the moveable apparatus).

Automotive manufacturers are shifting towards software defined vehicles, where vehicle features continue to evolve through software updates, even after the vehicle is sold. Vehicles can undergo software modifications while in use, including two or more years post-purchase. OTA software updates enable upgrades to programmable hardware within the vehicle. Hardware components that support programmability allow for software updates via OTA mechanisms. Processors across various vehicle hardware systems can be designed to be upgradable, with software images stored in dedicated non-volatile storage for each processor on respective circuit boards.

While processors, including traditional central processing units (CPUs), execute high-level software, power management hardware can govern the sequencing of power supply activation and perform monitoring functions. These components can contribute to both system efficiency and operational safety. As complexity in power management devices increases, power management devices may incorporate their own firmware. The firmware may execute on specific hardware components, and due to increasing complexity, non-volatile storage may be integrated within power management hardware to support firmware execution.

With OTA update capabilities, software fixes can be applied remotely without user intervention. This capability of firmware updates is extended to PMICs to introduce similar benefits. Implementing OTA updates for PMICs is challenging due to storage constraints. Traditional non-volatile storage solutions in processors provide memory capacities in the range of megabytes, whereas PMICs typically contain only a few kilobytes of memory. Conventional OTA methodologies that rely on redundant firmware executable images may not be viable for PMICs due to these storage limitations.

In one or more implementations, the subject technology provides for efficiently programming PMIC firmware to enable OTA updates within the storage constraints of power management hardware. The subject technology also helps achieve firmware upgradeability comparable to processor firmware updates while maintaining reliability standards.

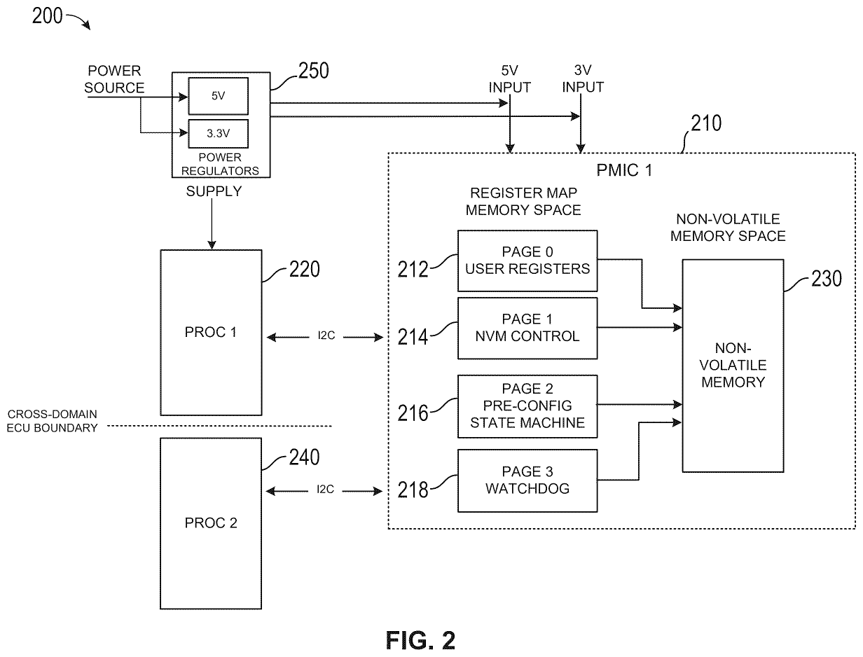

FIG. 2 illustrates an exemplary block diagram of a power management system 200 that includes a PMIC 210 (e.g., PMIC 1), a peripheral processor 220 (e.g., processor 1), a peripheral processor 240 and a power regulator circuit 250, in accordance with one or more implementations. In one or more implementations, power distribution and system control are managed by a power management integrated circuit (e.g., PMIC 210). A register map memory space is included within the PMIC 210, including multiple pages designated for different functionalities. A first page 212 (e.g., Page 0—User Registers) is configured to store user-configurable registers. A second page (e.g., Page 1—Non-Volatile Memory Control) is used to manage interactions with non-volatile memory. A third page (e.g., Page 2—Pre-Configurable State Machine) contains logic for predefined power states, while a fourth page (e.g., Page 3—Watchdog) is implemented to provide watchdog functionality for system reliability. The PMIC 210 is integrated with non-volatile memory 230, which receives the register map memory space as input to retain critical configuration data. The peripheral processor 220 is coupled to the PMIC 210 through a bidirectional communication bus (e.g., I2C), facilitating data exchange and control signals (e.g., clock). The peripheral processor 240 is coupled to the PMIC 210 through the bidirectional communication bus (e.g., I2C), facilitating data exchange and control signals across ECU domains. The power regulator circuit 250 provides voltage regulation and power distribution, receiving power from a renewable power source such as the battery pack 110 and generating stable output voltages, including a 5V power regulator supplying 5V output to components requiring higher voltage levels and a 3.3V power regulator providing 3.3V output for logic and low-power circuits. Both the PMIC 210 and the peripheral processor 220 receive power from the power regulator circuit 250, with the PMIC 210 receiving both 3.3V and 5V input. In one or more implementations, the PMIC 210 belongs to the same ECU as the peripheral processor 220. In one or more other implementations, the PMIC 210 and the peripheral processor 240 belong to different ECUs.

In one or more implementations, the PMIC 210 performs multiple functions within an automotive system. The PMIC 210 can monitor voltage levels supplied to various components on a printed circuit board (PCB) and performs safety monitoring functions such as temperature tracking and processor state monitoring. The PMIC 210 can facilitate safe communication with processors and manage system stability by shutting down malfunctioning components to prevent cascading failures. In one or more other implementations, the PMIC 210 may be responsible for powering the entire automotive system, acting as the first component to initialize and subsequently distributing power through various voltage rails.

In traditional power management systems, power management devices may operate under the control of a host controller or a master processor due to limited onboard intelligence. In one or more other implementations, advancements in PMIC capabilities allow these devices to manage control flows independently. For example, PMICs can execute sequential operations, monitor system states, and adapt control flows dynamically. This may eliminate the necessity of a host controller that was previously required for PMIC operation. Given the limited storage capacity of power management devices such as PMIC 210, efficient firmware upgrade methodologies are beneficial to facilitate robust firmware execution, as failures at this level can disrupt the entire automotive system due to its role as a primary power source.

In one or more implementations, OTA updates for processors utilize an A/B redundancy method. This redundancy method may involve maintaining two copies of the firmware, where a primary (A) copy executes by default, and a secondary (B) copy serves as the update target. During an upgrade, the B copy is programmed and validated before switching execution from A to B. This approach can improve reliability by preventing the system from switching to a corrupted firmware version due to power loss or integrity faults during programming. Until validation is complete, execution remains on a stable copy such as the primary A copy. While this redundancy can increase storage requirements, it can be beneficial to enhance reliability.

In PMICs, storage constraints introduce challenges for implementing traditional A/B redundancy method. Unlike processors, which utilize external non-volatile storage with configurable capacity, PMIC storage may be integrated within the IC and predetermined by the supplier. This can prevent flexibility in storage allocation, limiting the feasibility of OTA update mechanisms such as the traditional A/B redundancy method. In one or more implementations, the traditional A/B redundancy method used in processors may not be applicable to PMIC firmware updates, as only a single copy of the firmware can exist on the PMIC. During an OTA update, the existing firmware is overwritten, eliminating the ability to revert to a prior working state if an update failure occurs. To address these limitations, embodiments of the subject technology provide for utilizing multiple interconnected ECUs. In a vehicle architecture, multiple ECUs can communicate over dedicated buses. By leveraging these existing communication links, an OTA update process can be performed using interconnected ECUs to facilitate firmware programming on PMICs. In one or more other implementations, system reliability can be maintained by leveraging a peripheral processor that can continuously verify the integrity of the OTA update throughout the process.

In one or more implementations, the bidirectional communication bus implemented as an I2C interface is chosen as the communication protocol due to its capability to function in a master-slave configuration, allowing a single master to communicate with multiple slave devices. For example, the PMIC 210 can operate as a slave, with the peripheral processor 220 acting as a master. Communication with a specific PMIC can be determined by its unique slave address. In this example, the peripheral processor 220 serves as the master, interfacing with a slave PMIC (e.g., the PMIC 210) via the I2C interface, enabling controlled programming and updates across the power management system. In one or more other implementations, the peripheral processor 240 also can serve as a master at a different time than the peripheral processor 220, interfacing with a slave PMIC (e.g., the PMIC 210) via the I2C interface.

Since the I2C interface supports only a single master, the peripheral processor 220 may not update its own PMIC (e.g., the PMIC 210) directly. This limitation arises because the PMIC 210 supplies power to the peripheral processor 220. If the peripheral processor 220 were to attempt updating its own PMIC (e.g., the PMIC 210) while relying on it for power, a failure scenario may occur where the peripheral processor 220 becomes non-functional mid-update. To avoid this issue, control is transferred to the peripheral processor 240.

In one or more implementations, the memory space of peripheral processors such as the peripheral processor 240 may serve as a master processor to facilitate OTA programming of PMIC firmware. Once an OTA update is initiated by the peripheral processor 240, the peripheral processor 240 can receive the firmware executable images and extract relevant portions of executable images for PMIC firmware updates. The firmware executable image, received as a single package from a content source over a network, contains updates for both peripheral processors and PMICs across multiple ECUs. In one or more implementations, the peripheral processor 240 can temporarily store the firmware executable images and performs validation checks before transferring the firmware executable image to the PMIC 210. During this process, integrity checks can be conducted to confirm successful data transfer. If a power loss or other catastrophic failure occurs during firmware programming, the peripheral processor 240, which can continuously monitor the integrity of the OTA update on the PMIC 210, can detect the failure and initiate one or more retry attempts. The peripheral processor 240 can remain aware of unsuccessful OTA update attempts and can continue retries until the firmware programming is successfully completed on the PMIC 210. If a non-recoverable fault prevents the PMIC 210 from being programmed, the peripheral processor 240 can communicate the failure to the broader system, potentially displaying a message on an in-vehicle dashboard or the like indicating that a fault has occurred in one of the ECUs.

During OTA programming, the peripheral processor 240 can store a firmware executable image in its own memory while concurrently writing the data to the PMIC 210. As the peripheral processor 240 programs the PMIC 210, it performs integrity checks, including checksum verification and boot signature validation, to determine that the new firmware image is correctly written and that the PMIC 210 successfully initializes. The write operation can be validated through a cyclic redundancy check (CRC) or equivalent checksum verification to ensure data integrity. In one or more other implementations, the peripheral processor 240 attempts to boot the updated PMIC (e.g., PMIC 210) and verify its operational status by checking for a predefined signature indicating a successful update. If a fault occurs during the writing process, the original firmware copy is disrupted, and the PMIC 210 enters a non-functional state. To recover from this, the peripheral processor 240 initiates a retry mechanism, reattempting the OTA update until a successful firmware installation is achieved.

The retry mechanism may include a programmable timeout threshold, defining the number of allowed reattempts before determining that a critical hardware issue exists. If consecutive retries fail, the peripheral processor 240 may notify the broader system, potentially issuing a service alert instructing a user of the vehicle 100 to take the vehicle 100 to a service station for manual intervention. This approach may align with standard OTA failure handling in other domains, where an inability to complete an update, even with a fallback image available, is considered a critical issue requiring service intervention. In one or more other implementations, if a vehicle manufacturer relies on OTA updates to deliver new features and enhancements, the inability to update the PMIC 210 firmware over time may necessitate servicing to restore full system functionality.

The retry mechanism for OTA updates can be configured to assume that all faults are recoverable, configuring an arbitrary number of retry attempts before determining that a failure is critical. The peripheral processor 240 may not initially differentiate between minor and severe faults but instead follows a predefined retry process to attempt recovery. For transient faults, such as a temporary power loss, a subsequent retry may successfully complete the OTA update. In one or more other implementations, if the issue is caused by a non-recoverable hardware failure—such as a permanent fault in the internal memory of the PMIC 210 that prevents it from retaining the programmed state—this condition may only be detected after multiple failed retries. In some aspects, the peripheral processor 240 may determine that additional retries may not resolve the issue and escalate the fault for further intervention. While the retry mechanism may not dynamically adjust based on the fault type, repeated failures may indicate a potentially irrecoverable hardware issue, prompting notification to the broader system or triggering a service alert.

If the PMIC 210 fails to complete an OTA update and a cross-domain recovery mechanism is unavailable, affected ECUs may become non-functional, requiring manual reprogramming at a factory service center. To mitigate this risk, a cross-domain ECU with sufficient memory is leveraged to perform multiple reset attempts and restore the PMIC 210 to an operational state. This can enhance system resilience by applying OTA principles to a hardware-constrained environment.

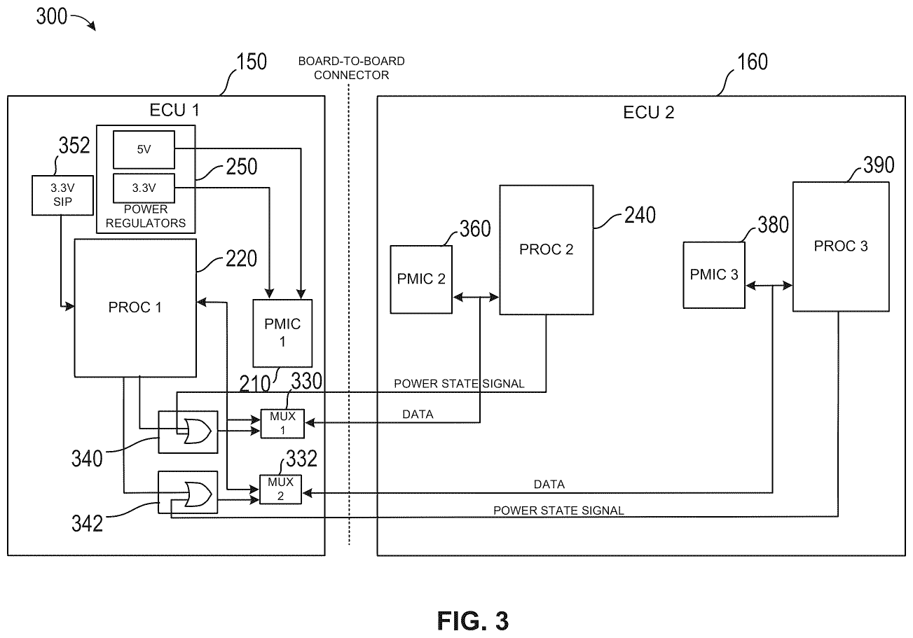

FIG. 3 illustrates an exemplary block diagram of enhanced over-the-air programming of power management integrated circuits between interconnected in-vehicle electronic control units in accordance with one or more implementations. In one or more implementations, FIG. 3 illustrates a power management system 300 in which the ECU 150 is interconnected with the ECU 160 via a board-to-board connector, enabling communication and power distribution between the two electronic control units. In one or more implementations, the ECU 150 may be responsible for infotainment functions such as display and entertainment system management in the vehicle 100, whereas the ECU 160 may function as the autonomy control module that is responsible for self-driving operations of the vehicle 100. As illustrated in FIG. 3, the ECU 150 and ECU 160 are separated by a delineated boundary representing two different printed circuit boards.

The ECU 150 can integrate multiple power management and processing components, including the power regulator circuit 250, the peripheral processor 220 and the PMIC 210, as described in FIG. 2. The power regulator circuit 250 can receive power from an external source and generates regulated voltage levels for the operation of components within the ECU 150. The PMIC 210 can manage power distribution and system control, while the peripheral processor 220 facilitates processing and communication functions with the PMIC 210.

As illustrated in FIG. 3, the ECU 160 contains multiple power management ICs and processors, facilitating independent power regulation for different processing units. The ECU 160 includes a PMIC 360 directly coupled to the peripheral processor 240, providing regulated power to support operation of the peripheral processor 240. In one or more other implementations, the ECU 160 includes a PMIC 380 directly coupled to a peripheral processor 390, supplying power to the peripheral processor 390. The inclusion of multiple PMICs in the ECU 160 allows for efficient power distribution, regulation, and management across different functional blocks within the ECU 160.

In one or more implementations, the ECU 150 and ECU 160 may be interconnected through various possible communication interfaces, including board-to-board connectors, PCIe, or Ethernet-based connections. As illustrated in FIG. 3, the board-to-board connector facilitates the electrical and data connections for seamless integration between the ECU 150 and the ECU 160, allowing for coordinated operation of the system as a whole. This communication may enable control, monitoring, and configuration of power management parameters across the interconnected ECUs. In one or more other implementations, the peripheral processor 220 within the ECU 150 may be configured to communicate with both the PMIC 360 and the PMIC 380 in the ECU 160 over separate I2C interfaces.

The OTA update process can involve multiple PMICs across two ECUs, requiring a controlled sequence for updating firmware. The PMICs associated with each ECU (e.g., ECU 150, ECU 160) may be targets for a software update process. The OTA update process can utilize I2C interfaces, with a dedicated I2C connection between a peripheral processor serving as a master and each PMIC serving as a slave.

As illustrated in FIG. 3, the power management system 300 includes multiplexers 330 and 332 that facilitate switching between different PMICs and facilitate dynamic master-slave role changes during the OTA update process. These MUX components can be beneficial to accommodate the possibility of switching the master processor at different stages of the OTA update process.

In one or more implementations, an OTA update can be received over a network (e.g., cellular), with the peripheral processor 220 downloading and storing firmware executable images in its local memory for both the ECU 150 and the ECU 160. The storage capacity of the peripheral processor 220 may be allocated accordingly to store the received firmware executable images. In one or more implementations, the peripheral processor 220 may serve as the master, enabling multiplexer connections to allow communication with the PMIC 360 and the PMIC 380. Given that the peripheral processor 220 may be configured to not update the PMIC 210 directly, the OTA process may begin with the firmware update of the PMIC 360. For example, the peripheral processor 220 can cause the multiplexer 330 to enable a multiplexer connection between the peripheral processor 220 and the PMIC 360 over the dedicated I2C interface. In this regard, the peripheral processor 220 can access the PMIC 360 by way of its slave address via the I2C interface and write the firmware update to memory of the PMIC 360. The peripheral processor 220 can check for the completion status of the OTA update, with retries performed as needed. If multiple retries fail, the peripheral processor 220 can notify the user of the vehicle 100 that the PMIC 360 is non-functional before disabling the path to the PMIC 360. Once PMIC 360 is successfully updated, a similar process is carried out for the PMIC 380 by reconfiguring the MUX connections such as disabling the multiplexer connection between the peripheral processor 220 and the PMIC 360 and enabling a multiplexer connection between the peripheral processor 220 and the PMIC 380.

In one or more implementations, the firmware programming of the PMIC 360 and the PMIC 380 can occur sequentially due to the shared I2C interface with the peripheral processor 220. In one or more other implementations, the firmware programming of the PMIC 360 and the PMIC 380 can be performed in parallel provided that separate I2C interfaces to the peripheral processor 220 are allocated for each PMIC. The slave addressing mechanism of the shared bus can ensure that the correct PMIC is targeted for OTA updates.

After updating the PMIC 360 and the PMIC 380, the peripheral processor 220 can power on the peripheral processor 240, initiating a handshake sequence to confirm readiness of the peripheral processor 240. For example, the peripheral processor 240 may be configured to cause the peripheral processor 220 to power off and enable a second connection between the peripheral processor 240 and the PMIC 210 upon successful completion of the handshaking sequence. In this regard, the peripheral processor 240 can assume control from the peripheral processor 220 to perform an OTA update of the PMIC 210, enabling the relevant multiplexer connection to the PMIC 210, keeping the peripheral processor 220 powered off during the OTA update of the PMIC 210, and writing the firmware update to the PMIC 210. In one or more implementations, the peripheral processor 240 may be responsible for initiating a power-down sequence of the peripheral processor 220. The peripheral processor 240 may enable the multiplexer 330 and then power off the peripheral processor 220, facilitating the correct sequencing of operations. The combinational logic circuit 340 is beneficial in this configuration to maintain the correct logic level for the enable signal to the multiplexer 330, preventing incorrect states that may interfere with the OTA update process.

A final handshake between the peripheral processor 240 and the peripheral processor 220 can ensure the OTA update of the PMIC 210 is successfully applied, after which the peripheral processor 220 is powered back on by the peripheral processor 240. This approach facilitates a controlled update sequence while maintaining system integrity and avoiding potential failures due to power dependencies between peripheral processors and their respective PMICs. In one or more other implementations, a separate control interface may exist between the peripheral processors (e.g., 220, 240, 390) for inter-processor communication, allowing management signaling to confirm power states and ensure the appropriate conditions for OTA updates.

The handshaking sequence between the peripheral processor 220 and the peripheral processor 240 may be a designated operation, where either peripheral processor can initiate communication. This approach can help prevent both peripheral processors (e.g., 220, 240) from attempting to initiate the OTA update simultaneously, facilitating a controlled OTA update process.

In one or more implementations, the enable signal for each multiplexer (e.g., 330, 332) is controlled by the power state of the peripheral processors 220, 240, 390. When a peripheral processor is powered off, it cannot assert the enable signal to a multiplexer, requiring the enable signal to originate from an active (or powered on) peripheral processor. This logic can ensure that only the powered-on peripheral processor can control the multiplexer and initiate communication with a PMIC. In one or more implementations, the multiplexer can remain active during the OTA update process. In one or more other implementations, the multiplexer can be non-permanently disabled after completion of the OTA update process with that PMIC to prevent interference between the ECU 150 and the ECU 160 in normal operation.

In one or more other implementations, combinational logic can be input to a multiplexer to determine the state of that multiplexer such that the combinational logic output allows only one peripheral processor to assert control over a PMIC at any given time. As illustrated in FIG. 3, combinational logic circuit 340 is coupled to the multiplexer 330, in which the combination logic circuit 340 receives a power state control signal from each of the peripheral processor 220 and the peripheral processor 240 to determine whether the peripheral processor 220 can assert control over the PMIC 360 via the multiplexer 330. Similarly, combinational logic circuit 342 is coupled to the multiplexer 332, in which the combination logic circuit 342 receives a power state control signal from each of the peripheral processor 220 and the peripheral processor 390 to determine whether the peripheral processor 220 can assert control over the PMIC 380 via the multiplexer 332. If two or more peripheral processors are powered on, the combinational logic can sense that multiple peripheral processors are active thus de-asserting its output signal, keeping the multiplexer disabled. If only one processor is powered on, the combinational logic asserts its output signal to the multiplexer thus causing the multiplexer to enable the multiplexer connection between the active peripheral processor and PMIC to proceed with the OTA update. In one or more implementations, each of the combinational logic circuit 340 and combinational logic circuit 342 includes a logic gate such as an OR gate, AND gate, NOR gate, XOR gate, or the like.

In one or more implementations, the combinational logic can ensure that a multiplexer control signal remains stable, and functions as intended throughout the OTA update process. For example, the combination logic can control the enable signal of a multiplexer by providing a stable logical one to the enable signal input of the multiplexer to keep the multiplexer active when required. If the enable signal input is left floating, the enable signal input can assume an indeterminate value. In one or more implementations, the enable signal input may be tied to a weak pull-down resistor to default the enable signal input to a logical zero when inactive. In one or more implementations, the enable signal input may be tied to a strong pull-up resistor to assert a logical one when needed. This configuration can ensure that the MUX control signal remains stable, and functions as intended throughout the OTA update process.

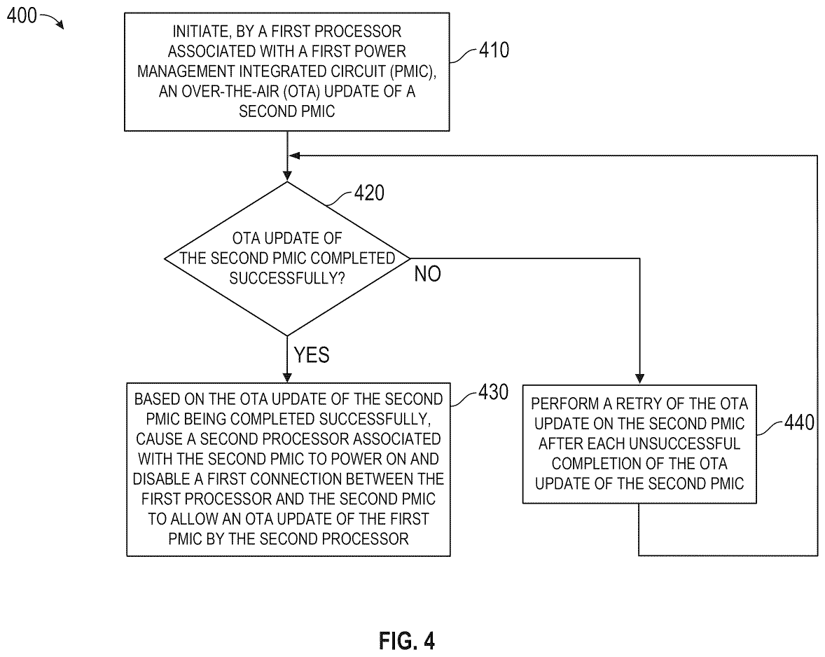

FIG. 4 is a flow diagram of illustrative operations of a process 400 that may be performed for enhanced over-the-air programming of power management integrated circuits in accordance with one or more implementations. The flow diagram may be implemented by a power management system shown and/or described herein. For explanatory purposes, the process 400 is primarily described herein with reference to the vehicle 100 of FIGS. 1A and 1B, the peripheral processors 220 or 240 of FIG. 2, the peripheral processor 390 of FIG. 3, and/or various components thereof. However, the process 400 is not limited to the vehicle 100 of FIGS. 1A and 1B, the peripheral processors 220 or 240 of FIG. 2, the peripheral processor 390 of FIG. 3, and one or more blocks (or operations) of the process 400 may be performed by one or more other structural components of the vehicle 100 and/or of other suitable moveable apparatuses, devices, or systems. Further, for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 410, a first processor (e.g., the peripheral processor 220 of FIG. 2) associated with a first PMIC (e.g., the PMIC 210 of FIG. 2) can initiate an OTA update of a second PMIC (e.g., the PMIC 360 of FIG. 2). In some aspects, the first PMIC and the second PMIC belong to different ECUs or are located in different domains or zones. In one or more implementations, the first processor may store PMIC executable images received over a network. In one or more implementations, at least a portion of the PMIC executable images are stored on the second PMIC during the OTA update of the second PMIC. In one or more implementations, the first processor is configured to initiate the OTA update of the second PMIC by enabling the first connection while the second processor is powered down.

At block 420, the first processor determines whether the OTA update of the second PMIC completed successfully, as described herein with reference to FIG. 3. If the OTA update completed successfully, the process 400 proceeds to block 430. Otherwise, the process 400 proceeds to block 440.

At block 430, based on the OTA update of the second PMIC being completed successfully, the first processor can cause a second processor associated with the second PMIC to power on and disable a first connection between the first processor and the second PMIC to allow an OTA update between the second processor and the first PMIC to take place thereafter if needed. In one or more implementations, the second processor may be configured to perform a handshake sequence with the first processor to initiate an OTA update of the first PMIC upon successful completion of the OTA update of the second PMIC. The second processor may be configured to cause the first processor to power off and enable a second connection between the second processor and the first PMIC upon successful completion of the handshake sequence. The second processor may be further configured to initiate the OTA update of the first PMIC over the second connection, determine that the OTA update of the first PMIC completed successfully, and cause the first processor to power on and disable the second connection to complete the OTA update of the first PMIC based on the OTA update of the first PMIC being completed successfully. In one or more other implementations, the first connection and the second connection are controlled through a multiplexer that switches between the first connection and the second connection using a combinational logic circuit as input to the multiplexer. In some aspects, a power state signal from each of the first processor and the second processor are input to the combinational logic circuit.

At block 440, the first processor may perform a retry of the OTA update on the second PMIC after each unsuccessful completion of the OTA update of the second PMIC. In one or more implementations, the first processor may generate a user notification indicating that the second PMIC is non-functional after a number of retries of the OTA update on the second PMIC and disable the first connection following the user notification. After each retry, the process 400 may return to block 420 to determine whether the OTA update after the retry completed successfully.

The methods described herein, combining direct sensing, integrated temperature monitoring, and strategic packaging, represents an approach to low voltage battery management in electric vehicles. The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone-specific electronic control units (ECUs).

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system comprising:
a first electronic control unit (ECU) comprising a first power management integrated circuit (PMIC) and a first processor; and
a second ECU comprising a second PMIC and a second processor,
wherein the first processor is configured to:
initiate an over-the-air (OTA) update of the second PMIC,
determine that the OTA update of the second PMIC completed successfully, and
based on the OTA update of the second PMIC being completed successfully, cause the second processor to power on and disable a first connection between the first processor and the second PMIC to allow an OTA update between the second processor and the first PMIC.

2. The system of claim 1, wherein one or more of the first processor or the second processor stores PMIC executable images received over a network, and wherein at least a portion of the PMIC executable images are stored on the second PMIC during the OTA update of the second PMIC.

3. The system of claim 1, wherein the first processor is configured to initiate the OTA update of the second PMIC by enabling the first connection while the second processor is powered down.

4. The system of claim 1, wherein the first processor is further configured to perform a retry of the OTA update on the second PMIC after each unsuccessful completion of the OTA update of the second PMIC.

5. The system of claim 4, wherein the first processor is further configured to generate a user notification indicating that the second PMIC is non-functional after a number of retries of the OTA update on the second PMIC and disable the first connection following the user notification.

6. The system of claim 1, wherein the second processor is configured to perform a handshake sequence with the first processor to initiate an OTA update of the first PMIC upon successful completion of the OTA update of the second PMIC.

7. The system of claim 6, wherein the second processor is further configured to:
cause the first processor to power off, and
enable a second connection between the second processor and the first PMIC upon successful completion of the handshake sequence.

8. The system of claim 7, wherein the second processor is further configured to:
initiate the OTA update of the first PMIC over the second connection,
determine that the OTA update of the first PMIC completed successfully, and
based on the OTA update of the first PMIC being completed successfully, cause the first processor to power on and disable the second connection to complete the OTA update of the first PMIC.

9. The system of claim 7, wherein the first connection and the second connection are controlled through a multiplexer that switches between the first connection and the second connection using a combinational logic circuit as input to the multiplexer.

10. The system of claim 9, wherein a power state signal from each of the first processor and the second processor are input to the combinational logic circuit.

11. The system of claim 1, wherein the first ECU and the second ECU are connected via a board-to-board connector.

12. A first electronic control unit (ECU), comprising:
a first processor; and
a first power management integrated circuit (PMIC),
wherein the first processor is configured to:
initiate an over-the-air (OTA) update of a second PMIC in a second ECU connected to the first ECU,
determine whether the OTA update of the second PMIC completed successfully,
based on the OTA update of the second PMIC being completed successfully, cause a second processor in the second ECU to power on and disable a first connection between the first processor and the second PMIC to allow an OTA update between the second processor and the first PMIC, and
based on the OTA update of the second PMIC not being completed successfully, perform a retry of the OTA update on the second PMIC after each unsuccessful completion of the OTA update of the second PMIC.

13. The first ECU of claim 12, wherein the first processor is configured to initiate the OTA update of the second PMIC by enabling the first connection while the second processor is powered down.

14. The first ECU of claim 12, wherein the first processor is further configured to perform a retry of the OTA update on the second PMIC after each unsuccessful completion of the OTA update of the second PMIC.

15. The first ECU of claim 14, wherein the first processor is further configured to generate a user notification indicating that the second PMIC is non-functional after a number of retries of the OTA update on the second PMIC and disable the first connection following the user notification.

16. The first ECU of claim 12, wherein the first processor is configured to perform a handshake sequence with the second processor for the second processor to initiate an OTA update of the first PMIC upon successful completion of the OTA update of the second PMIC.

17. A method comprising:
receiving, by a first processor associated with a first power management integrated circuit (PMIC), executable images for programming the first PMIC and a second PMIC;
initiating, by the first processor, an over-the-air (OTA) update of the second PMIC;
determining that the OTA update of the second PMIC completed successfully; and
based on the OTA update of the second PMIC being completed successfully, causing, by the first processor, a second processor associated with the second PMIC to power on and disabling a first connection between the first processor and the second PMIC to allow an OTA update between the second processor and the first PMIC.

18. The method of claim 17, further comprising performing, by the first processor, a retry of the OTA update on the second PMIC after each unsuccessful completion of the OTA update of the second PMIC.

19. The method of claim 18, further comprising:
generating, by the first processor, a user notification indicating that the second PMIC is non-functional after a number of retries of the OTA update on the second PMIC; and
disabling, by the first processor, the first connection following the user notification.

20. The method of claim 17, further comprising performing, by the first processor, a handshake sequence with the second processor for the second processor to initiate an OTA update of the first PMIC upon successful completion of the OTA update of the second PMIC.
